(19) United States
(12) Patent Application Publication
(10) Pub. No.: US 2016/0354714 A1
(43) Pub. Date: Dec. 8, 2016

(54) Filter, Filter Element, and Filter Housing

(71) Applicant: MANN+HUMMEL GMBH, Ludwigsburg (DE)

(72) Inventors: Martin Klein, Ludwigsburg (DE); Charles Vaillant, Holly Springs, NC (US); Elham Amirnasr, Cary, NC (US); Pamela Gohl, Remseck (DE); Rajan Ahuja, Fayetteville, NC (US); Michael Desjardins, Schoolcraft, MI (US)

(21) Appl. No.: 15/174,300

(22) Filed: Jun. 6, 2016

Related U.S. Application Data
(60) Provisional application No. 62/170,918, filed on Jun. 4, 2015.

(51) Int. Cl. B01D 35/00; B01D 29/21; B01D 39/18; B01D 29/15; B01D 35/30

(52) U.S. Cl. CPC B01D 35/005; B01D 29/15; B01D 35/30; B01D 39/18; B01D 29/21; B01D 2239/0407; B01D 2239/065; B01D 2239/0695

(57) ABSTRACT

Disclosed is a filter (10) for liquid fluid, in particular lubricant, particularly motor oil, or fuel, in particular of an internal combustion engine, a filter element (16) and a filter housing (12). The filter housing (12) has at least one inlet (24) for fluid to be cleaned and at least one outlet (22) for cleaned fluid. The filter (10) has at least one hollow filter element (16), which is arranged in the filter housing (12) such that it separates at least one inlet (24) from at least one outlet (22). The filter element (16) has at least one filter medium (26), which is at least partly surrounding at least one internal space (28) of the filter element (16) circumferentially relating to an axis (20). The at least one filter element (16) has at least one passage (34) for connecting at least one internal space (28) fluid-ducting to at least one inlet (24) or at least one outlet (22). The filter (10) has at least one medium (48) for neutralization of acid in the fluid and/or for sequestering acid from the fluid, which is arranged in a fluid-ducting area of the filter (10) such that the fluid can come in contact at least with a part of the medium for acid neutralization/sequestration (48). At least one medium for acid neutralization/sequestration (48) is laminar and different from the at least one filter medium (26).

### CROSS-REFERENCE TO RELATED APPLICATION

This application claims the benefit of U.S. Provisional Application No. 62/170,918, filed Jun. 4, 2015.

### TECHNICAL FIELD

The present invention relates to a filter for liquid fluid, in particular lubricant, particularly motor oil, or fuel, in particular of an internal combustion engine, in particular of a motor vehicle, with a filter housing, which is comprising at least one inlet for fluid to be cleaned and at least one outlet for cleaned fluid, with at least one hollow filter element, which is arranged in the filter housing such that it separates at least one inlet from at least one outlet, wherein the filter element comprises at least one filter medium, which is at least partly surrounding at least one internal space of the filter element circumferentially relating to an axis, wherein the at least one filter element comprises at least one passage for connecting at least one internal space fluid-ducting to at least one inlet or at least one outlet, and wherein the filter comprises at least one medium for neutralization of acid in the fluid and/or for sequestering acid from the fluid, which is arranged in a fluid-ducting area of the filter such that the fluid can come in contact at least with a part of the medium for acid neutralization/sequestration.

Further, the invention relates to a filter element, in particular a hollow filter element, of a filter for liquid fluid, in particular lubricant, particularly motor oil, or fuel, in particular of an internal combustion engine, in particular of a motor vehicle, which can be arranged in a filter housing such that it separates at least one inlet for fluid to be cleaned and at least one outlet for cleaned fluid, wherein the filter element comprises at least one filter medium, which is at least partly surrounding at least one internal space of the filter element circumferentially relating to an axis, wherein the filter element comprises at least one passage for connecting at least one internal space fluid-ducting to at least one inlet or at least one outlet, wherein the filter comprises at least one medium for neutralization of acids in the fluid and/or for sequestering acid from the fluid, which is arranged in a fluid-ducting area of the filter element such that the fluid can come in contact at least with a part of the medium for acid neutralization/sequestration.

Furthermore, the invention relates to a filter housing of a filter for liquid fluid, in particular lubricant, particularly motor oil, or fuel, in particular of an internal combustion engine, in particular of a motor vehicle, wherein the filter housing is comprising at least one inlet for fluid to be cleaned and at least one outlet for cleaned fluid, wherein at least one filter element can be arranged in the filter housing such that it separates at least one inlet from at least one outlet, wherein the filter comprises at least one medium for neutralization of acid in the fluid and/or for sequestering acid from the fluid, which can be arranged in a fluid-ducting area of the filter housing such that the fluid can come in contact at least with a part of the medium for acid neutralization/sequestration.

### BACKGROUND

WO 2009/099882 A2 discloses filter elements for sequestering acids from oil or fuel, strong base flocs that comprise the filter elements, and methods of their preparation and use. The filter elements comprise an acid sequestering filter medium in form of a mechanically linked interlocking fiber matrix interspersed with strong base particle flocs wherein the strong base particles constitute at least 30% by weight of the filter element. Certain filter elements may be useful for sequestering acids or neutralized acids in certain oils or fuels, for example, the acids originating in the combustion and lubrication system of an internal combustion engine or those contained in oils in an oil circulation system. Other filter elements may be useful for reducing oxidation of oil.

### SUMMARY OF THE INVENTION

It is an object of the invention to provide a filter and a filter element of the above-mentioned kind, which can reduce expenditure in material and/or in manufacturing and/or can increase lifetime of the filter and/or the oil.

The object is achieved by that, at least one medium for acid neutralization/sequestration is laminar and different from the at least one filter medium.

In the sense of the invention, laminar means that the at least one medium for acid neutralization/sequestration extends over an area. The area can at least partly be flat and/or bent.

According to the invention, the filter incorporates at least the function of filtration of particles and neutralizing and/or sequestering acids, wherein the function of filtration and the function of neutralizing/sequestering the acids are not combined in one part or material, in particular in one media layer. So, the characteristics, in particular performances, of the at least one filter medium and the at least one medium for neutralizing/sequestering acids can be optimized for their individual function each. The materials of the filter medium and the medium for neutralization/sequestering acids can be different. Particularly, for the filter medium simpler, in particular costs-efficient, materials can be used. In particular for use with an oil filter of a motor vehicle, particularly a passenger car, low-cost cellulose media for filtration can be used. It is not necessary to use a combined synthetic media layer for filtration and acid neutralization, which are more expensive. Further, a thickness of the filter medium and/or of the medium for neutralizing/sequestering acids can be reduced compared to a medium which combines the function of filtration and the function of neutralizing/sequestering acid. Thinner media can be formed, in particular pleated or bent, easier.

With the at least one medium for acid neutralization/sequestering acids in the fluid can be removed. The acids can be removed from the fluid, in particular oil, during filtration process and before the fluid gets to its application side, in particular to engine parts. The acids can be produced from degradation of the fluid, in particular oil, in time. With the inventive filter, a service interval can be increased. Further, a wear and corrosion of engine parts can be reduced.

The function of filtration and acid neutralization/sequestration can be divided into two sections. Filtration function can be done by the at least one filter filter medium, in particular current synthetic and/or cellulose media. Acid neutralization/sequestration function can be done by the additional at least one medium for neutralizing/sequestering acids. It is not necessary that the at least one medium for acid neutralization/sequestration is suitable for filtering particles from the fluid. Particularly, at least one medium for acid neutralization/sequestration can be impermeable for fluid and particles or permeable for both, fluid and particles.

The at least one medium for neutralizing/sequestering acids can be placed in different parts of the filter, the filter element or the filter housing.

In one embodiment, at least two or more media for neutralizing/sequestering acids can be placed in different parts of the filter, the filter element or the filter housing.

Advantageously, at least one medium for neutralizing/sequestering acids can be wrapped around an inner and/or an outer circumference of the filter medium, in particular a particle filtration bellow. Additionally or alternatively, at least one medium for neutralizing/sequestering acids and at least one filter medium can be laminated.

Advantageously, the filter can be realized as a spin-on filter or an other kind of easy-change filter. The at least one filter element can be arranged exchangeable or not exchangeable in the filter housing.

A hollow filter element is characterized by at least one internal space which is at least partly surrounded by at least one filter medium. The fluid to be cleaned can flow through the filter medium from the outside of the filter element to the inside into the at least one internal space or vice versa. The at least one internal space has at least one passage for the fluid, through which, dependent on the flow direction, the cleaned fluid can leave the internal space or fluid to be cleaned can reach the internal space. The at least one filter medium can surround the at least one internal space circumferentially relating to an axis of the filter element. On at least one axial front side, the at least one filter medium can be connected to an end body, in particular an end plate. At least one end body can comprise at least one sluiceway for the at least one internal space.

Advantageously, the hollow filter element can be realized as a circular filter element with a round cross-section, an oval filter element with an oval cross-section, a flat-oval filter element with a flattened oval cross-section, a conical-circular filter element, in which the round cross-section tapers in direction axial to a principal axis, a conical-oval filter element, in which the oval cross-section tapers at least in direction of one minor axis, or as a hollow filter element with a different cross-section, in particular an angled cross-section, and/or a different cross-sectional profile.

Advantageously, at least one filter medium can be closed or open in circumferential direction relating to the axis of the element. Particularly, at least one filter medium can be bent or folded. In particular, the at least one filter medium can be bent or folded star-shaped, favorably in kind of a zigzag or wavelike. The at least one filter medium can also be non-folded or non-bent.

The invention can be used with a lubrication circuit of an internal combustion engine of a motor vehicle. The filter can be used as an filter, in particular oil filter, for cleaning lubricant, in particular lubricating or motor oil. The invention also can be used with a fuel system of an internal combustion engine of a motor vehicle. The filter then can be used as a fuel filter for cleaning fuel, in particular diesel fuel. The filter further can be utilized for cleaning other liquid fluids. The invention furthermore can be applied in technical areas beyond automotive engineering. In particular, the invention can be used with industrial engines.

According to a favorable embodiment of the invention, at least one medium for acid neutralization/sequestration can be arranged such, that the fluid can flow against, passage through, circulate around and/or flow along a surface of said at least one medium for acid neutralization/sequestration. In this way, the fluid, in particular the acid, can get in contact with the at least one medium for acid neutralization/sequestration.

Advantageously, at least one medium for acid neutralization/sequestration can be arranged such, that the fluid can flow against said at least one medium for acid neutralization/sequestration. Thus, it is not necessary, that the at least one medium for acid neutralization/sequestration is permeable for the fluid. The at least one medium for acid neutralization/sequestration can be arranged in an area of the filter/filter element, where it is in contact with the fluid only at one of its two surfaces.

Alternatively or additionally, at least one medium for acid neutralization/sequestration can be arranged such, that the fluid can circulate around said at least one medium for acid neutralization/sequestration. Thus, it is not necessary, that the at least one medium for acid neutralization/sequestration is permeable for the fluid. The at least one medium for acid neutralization/sequestration can be arranged in an area of the filter/filter element, where it is in contact with the fluid only at one surface or at both of its surfaces. So, an active area for acid neutralization/sequestration of the at least one medium can be increased.

Alternatively or additionally, at least one medium for acid neutralization/sequestration can be arranged such, that the fluid can passage through said at least one medium for acid neutralization/sequestration.

According to a further favorable embodiment of the invention, at least one medium for acid neutralization/sequestration can be realized in combination with at least one filter element and/or at least one medium for acid neutralization/sequestration can be realized in combination with the filter housing.

Advantageously, at least one medium for acid neutralization/sequestration can be realized in combination with at least one filter element. Thus, the at least one medium for acid neutralization/sequestration can be manufactured together with the at least one filter element. Combined with the at least one filter element it can be fitted into the filter housing. In case of a removable filter element, it also can be replaced together with said filter element.

Alternatively or additionally at least one medium for acid neutralization/sequestration can be realized in combination with the filter housing. So, it can be manufactured together with the filter housing.

According to a further favorable embodiment of the invention, at least one medium for acid neutralization/sequestration can be arranged on a circumferential side relating to the axis and/or at least one medium for acid neutralization/sequestration can be arranged on at least one axial front side of at least one filter element and/or the filter housing.

Advantageously, at least one medium for acid neutralization/sequestration can be arranged on a circumferential side relating to the axis.

Particularly, at least one medium for acid neutralization/sequestration can be arranged on a circumferential side of at least one filter element. Alternatively or additionally at least one medium for acid neutralization/sequestration can be arranged on a particularly radial inner circumferential side of the filter housing.

Alternatively or additionally, at least one medium for acid neutralization/sequestration can be arranged on at least one axial front side of the filter element. Particularly, only at one front side at least one medium for acid neutralization/sequestration can be arranged. Alternatively, on both fronts sides each at least one medium for acid neutralization/sequestration can be arranged.

Particularly, at least one medium for acid neutralization/sequestration can be arranged on at least one axial front side of at least one filter element. Alternatively or additionally, at least one medium for acid neutralization/sequestration can be arranged on at least one particularly axial inner front side, in particular a bottom or a cover, of the filter housing.

According to a further favorable embodiment of the invention, at least one medium for acid neutralization/sequestration can be arranged inside the internal space of the filter element and/or at least one medium for acid neutralization/sequestration can be arranged outside the internal space of the filter element.

Particularly, at least one medium for acid neutralization/sequestration can be arranged inside the internal space of the hollow filter element. Thus, the at least one medium can be arranged space-saving and/or protected.

Advantageously, at least one medium for acid neutralization/sequestration can be mounted on a center tube of the filter element. At least one medium for acid neutralization/sequestration can be arranged radial between the center tube and the filter medium.

Alternatively or additionally, at least one medium for acid neutralization/sequestration can be arranged outside the internal space of the hollow filter element. So, it can easier be assembled in case it is not connected to the filter element.

According to a further favorable embodiment of the invention, at least one medium for acid neutralization/sequestration can comprise or consist of at least one section, which extends circumferential and radial to the axis, in particular a kind of disk or doughnut, and/or at least one section, which extends circumferential and axial to the axis, in particular a kind of hollow body, particularly a hollow cylinder, a hollow cone or suchlike.

The disk, the doughnut, the hollow cylinder and the hollow cone can be round, oval, angular or shaped in a different way.

At least one medium for acid neutralization/sequestration can be formed, in particular cut, as required. Advantageously, at least one medium for acid neutralization/sequestration can be cut from a raw material. It can be formed in circle, doughnut or rectangular shape. The formed at least one medium for acid neutralization/sequestration can placed in open spaces of the filter housing and/or at least one filter element.

Advantageously, at least one doughnut shaped medium for acid neutralization/sequestration can be arranged on a top front side or top surface, in particular a top end plate, of at least one filter element.

Advantageously, at least one doughnut shaped medium for acid neutralization/sequestration can be arranged on a bottom front side or bottom surface, in particular a bottom end plate, of at least one filter element.

Advantageously, at least one doughnut shaped medium for acid neutralization/sequestration can be arranged on a top front side or top surface, in particular a top end plate, of at least one filter element and at least one doughnut shaped medium for acid neutralization/sequestration can be arranged on bottom front side or bottom surface, in particular a bottom end plate, of at least one filter element.

Advantageously, at least one round shaped medium for acid neutralization/sequestration can be arranged on the bottom of the filter housing. Particularly, at least one medium for acid neutralization/sequestration can be placed between a spring, which is placed between the at least one filter element and the bottom of the filter housing, and the bottom of the filter housing. Alternatively or additionally, at least one medium for acid neutralization/sequestration can be placed between a bypass valve and the spring. The bypass valve can be part of the at least one filter element.

Advantageously, at least one medium for acid neutralization/sequestration can be cylindrically stabilized to a circumferential wall of the filter housing. Favorably, the at least one medium for acid neutralization/sequestration can be attached to a radial inner circumferential side of the wall of the filter housing.

Advantageously, at least one medium for acid neutralization/sequestration can be cylindrically placed around the filter element like a sleeve. The at least one medium for acid neutralization/sequestration can extend over the full height of the filter element or only over a part of the height.

Advantageously, at least one medium for acid neutralization/sequestration can be cylindrically placed around a center tube of filter element.

For realizing a cylindrical form, particularly at least one rectangular shaped medium for acid neutralization/sequestration can be bent cylindrically.

According to a further favorable embodiment of the invention, at least one medium for acid neutralization/sequestration can be arranged upstream of at least one filter medium relating to the fluid flow and/or at least one medium for acid neutralization/sequestration can be arranged downstream of at least one filter medium.

Advantageously, at least one medium for acid neutralization/sequestration can be arranged upstream of at least one filter medium relating to the fluid flow. Thus, the acid can be neutralized/requested before the fluid enters the at least one filter medium.

Thus, the material of the at least one filter medium is not being contaminated with acid. So, the lifetime of the at least one filter medium can be extended.

Alternatively or additionally, at least one medium for acid neutralization/sequestration can be arranged downstream of at least one filter medium. Thus, the particles can be filtered out before the fluid reaches the at least one medium for acid neutralization/sequestration. So, the at least one medium for acid neutralization/sequestration not being blocked by particles. In this way, the lifetime of the at least one medium for acid neutralization/sequestration can be extended.

According to a further favorable embodiment of the invention, at least one medium for acid neutralization/sequestration can comprise at least one supporting material, in particular a matrix formed of mechanical-interlocking structural fibers and interstitial spaces, particularly a kind of textile and/or a nonwoven material.

Advantageously, at least one supporting material can consist of or comprise nonwoven material, in particular spunbond.

Alternatively or additionally, at least one supporting material can consist of or comprise a kind of textile material.

Since the medium for acid neutralization/sequestration does not fulfill the function of filtering, it is not necessary, that the at least one supporting material is permeable for the fluid. On the other hand, if it is permeable for the fluid it also can be permeable for particles in the fluid, since the particles are to be filtered by the at least one filter medium. Particularly, the sizes of interstitial spaces can be bigger than maximum occurring sizes of particles in the fluid.

According to a further favorable embodiment of the invention, at least one medium for acid neutralization/sequestration can comprise particles for acid neutralization/sequestration, in particular strong base particles.

By using strong base particles, it is not necessary, to add any additive to the fluid, in particular the lubricating oil or motor oil or fuel, for acid neutralization.

The term “acid sequestration” herein refers to the ability of a strong base to accept and/or retain combustion acids or organic acids previously in the fluid, in particular lubricating oil or motor oil or fuel, as either soluble free acids, or complexed and/or neutralized from/with detergents, dispersants, or other transfer agents.

The strong base particles can be realized as strong base flocs. The strong base particles can comprise strong base particles containing magnesium oxide or zinc oxide or combination thereof. The strong base particles can have an average particle size of about 0.1 to about 10 microns or larger. The strong base particles can have a high molecular weight flocculating agent. A floc formed from contacting of the flocculating agent and the strong base particles can have an average cross-section distance of greater than about 10 microns. The strong base particles in the floc can retain at least about 40% of their intrinsic surface area as measured by a mercury intrusion porosimetry.

The particles may be formed primarily from a strong base material itself. By “strong base” is meant a base that will displace the weak base from the neutral salts and return the weak base to the fluid for recirculation, in particular on the oil for recirculation to the piston ring zone, where the weak base may be reused to neutralize additional acids.

Examples of strong bases suitable for immobilization in solid base filters include, but are not limited to, barium oxide (BaO), calcium carbonate (CaCO₃), calcium oxide (CaO), calcium hydroxide (Ca(OH)₂) magnesium carbonate (MgCO₃), magnesium hydroxide (Mg(OH)₂), magnesium oxide (MgO), sodium aluminate (NaAlO₂), sodium carbonate (Na₂CO₃), sodium hydroxide (NaOH), zinc oxide (ZnO), zinc carbonate (ZnCO₃) and zinc hydroxide Zn(OH)₂ or their mixtures. Magnesium oxide and zinc oxide, or mixtures thereof, are preferred strong base materials.

According to a further favorable embodiment of the invention, at least one medium for acid neutralization/sequestration can comprise or consist of a supporting material on/in/at which particles for acid neutralization/sequestration are immobilized to.

The particles for neutralizing/sequestering the acids can be immobilized onto a particularly thin material, in particular on to fibers of said supporting material. The particles can be immobilized by being trapped between fibers of the material, especially of a fibrous filter media or a woven or nonwoven support layer. The particles can also be immobilized by being glued on to a layer or being held between two media layers. The particles may be immobilized in the media in a way that they cannot leave the media and enter the fluid stream. They are not only fixed in the functionalized media but also may be secured by a protection layer on the downstream side of functionalized media that prevents particles separation from media. In other embodiments the functionalized media is on the dirty side so if any particles got released from media they will stay on the dirty side. To avoid that the particles are released during handling, edges of the layers may be sealed in advantageous embodiments. The two different scenarios have been tested for the media migration and the result showed particles do not migrate to the clean side of the filter.

A cellulosic filter bellow of the filter can be individually formed. At least one layer of at least one medium for acid neutralization/sequestration, in particular a nonwoven media with the acid trap particles, can be wrapped either around outer pleat tips of the filter medium or around the radial inner circumferential side of the filter medium, in particular around a center tube of the filter element. The at least one medium for acid neutralization/sequestration can be wrapped over the entire height of the filter element or only over part of the height. It can be wrapped over the entire 360° circumferences or only on a segment of the circumference. One or more layers can be wrapped around the filter bellow and/or the center tube.

Alternatively or additionally, at least one layer of at least one medium for acid neutralization/sequestration can be laminated to a layer of filter medium of the filter, in particular a cellulose layer.

The at least one medium for acid neutralization/sequestration can be placed either on the upstream side or on the downstream side of the filtration layer. Both layers can be pleated together to one bellow.

The embodiments described above and below in connection with the drawings describe different arrangements how and where a medium for acid neutralization/sequestration can be integrated in a filter according to the invention. Depending on the specific application of a filter according to the invention there might arise the need for integrating more medium for acid neutralization/sequestration as it is feasible or possible in one of the separate arrangements described. Therefore, according to further embodiments of the invention, the filter comprises at least two or more media for neutralizing/sequestering acids that can be placed in different parts of the filter, the filter element or the filter housing.

At least one medium for acid neutralization/sequestration can comprise or consist of a acid removal nonwoven media. At least one medium for acid neutralization/sequestration can comprise at least two layers. It can comprise a two layer nonwoven, in particular a scrim layer and a particle loaded layer.

The object further is achieved by the filter element in that at least one medium for acid neutralization/sequestration is combined with at least one filter element, wherein the at least one medium for acid neutralization/sequestration is laminar and different from the at least one filter medium.

The object furthermore is achieved by the filter housing in that at least one medium for acid neutralization/sequestration is combined with the filter housing, wherein the at least one medium for acid neutralization/sequestration is laminar.

The above-mentioned advantages and characteristic features of the inventive filter, the inventive filter element and the inventive filter housing apply analogously among each other. The single advantages and characteristic features can be combined among each other.

### BRIEF DESCRIPTION OF DRAWINGS

The present invention together with the above-mentioned and other objects and advantages may best be understood from the following detailed description of the embodiments, but not restricted to the embodiments, wherein is shown schematically:

FIG. 1 illustrates a section view of filter housing and filter element according to a first embodiment;

FIG. 2 illustrates a section view of the filter element of FIG. 1, according to the first embodiment;

FIG. 3 illustrates a perspective view of the filter element of FIG. 1, according to the first embodiment;

FIG. 4 illustrates a section view of filter housing and filter element according to a second embodiment;

FIG. 5 illustrates a section view of the filter element of FIG. 4, according to the second embodiment;

FIG. 6 illustrates a perspective view of the filter element of FIG. 4, according to the second embodiment;

FIG. 7 illustrates a section view of filter housing and filter element according to a third embodiment;

FIG. 8 illustrates a section view of the filter element of FIG. 7, according to the third embodiment;

FIGS. 9-11 illustrate perspective views of the filter element of FIG. 7, according to the third embodiment;

FIG. 12 illustrates a section view of filter housing and filter element according to a fourth embodiment;

FIG. 13 illustrates a section view of the filter housing of FIG. 12, according to the fourth embodiment;

FIG. 14 illustrates a top view of the filter housing of FIG. 12, according to the fourth embodiment;

FIG. 15 illustrates a section view of filter housing and filter element according to a fifth embodiment;

FIG. 16 illustrates a section view of the filter housing of FIG. 15, according to the fifth embodiment;

FIG. 17 illustrates a top view of the filter housing of FIG. 15, according to the fifth embodiment;

FIG. 18 illustrates a section view of filter housing and filter element according to a sixth embodiment;

FIG. 19 illustrates a section view of the filter housing of FIG. 18, according to the sixth embodiment;

FIG. 20 illustrates a top perspective view of the filter housing of FIG. 18, according to the sixth embodiment;

FIG. 21 illustrates a section view of filter housing and filter element according to a seventh embodiment;

FIG. 22 illustrates a section view of the filter element of FIG. 21, according to the seventh embodiment;

FIG. 23 illustrates a perspective view of the filter element of FIG. 21, according to the seventh embodiment;

FIG. 24 illustrates a section view of filter housing and filter element according to an eighth embodiment;

FIG. 25 illustrates a section view of the filter element of FIG. 24, according to the eighth embodiment;

FIG. 26 illustrates a perspective view of the filter element of FIG. 24, according to the eighth embodiment;

FIG. 27 illustrates a section view of filter housing and filter element according to a ninth embodiment;

FIGS. 28 and 31 illustrates a section view of the filter element and its components of FIG. 27, according to the ninth embodiment;

FIGS. 29-30 and illustrate a perspective view of the filter element and its components of FIG. 27, according to the ninth embodiment;

FIG. 31 illustrates a section view of the filter element and its components of FIG. 27, according to the ninth embodiment;

FIG. 32 illustrates a section view of filter housing and filter element according to a tenth embodiment;

FIG. 33 illustrates a section view of the filter element of FIG. 32, according to the tenth embodiment; and

FIG. 34 illustrates a perspective view of the filter element of FIG. 32, according to the tenth embodiment.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION OF THE DRAWINGS

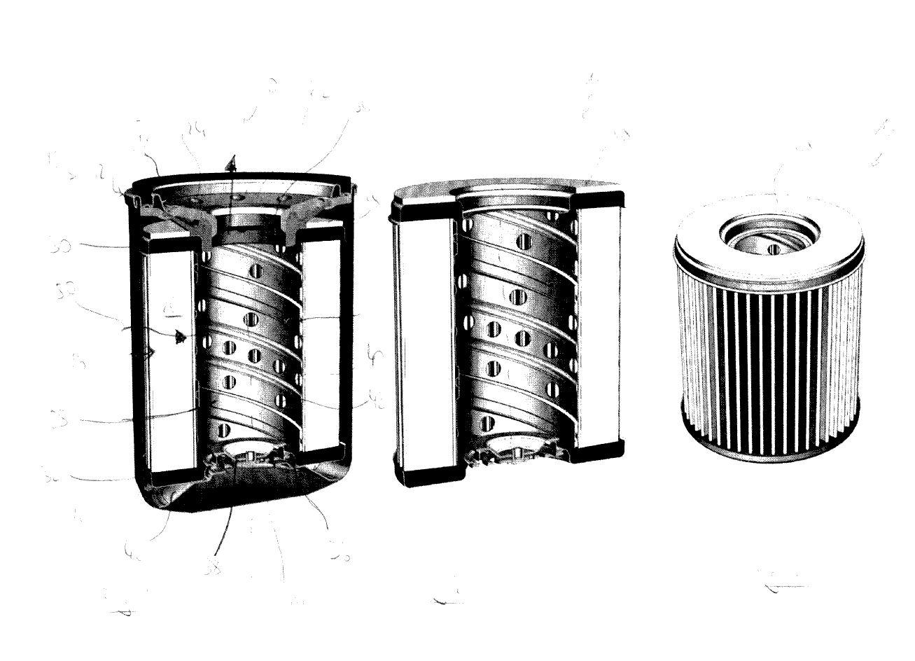

In FIG. 1 a filter 10 for motor oil of an internal combustion engine of a motor vehicle according to a first embodiment is shown in a longitudinal section. The filter 10 is arranged in a lubrication circuit of the internal combustion engine. With the filter 10 particles and acid in the motor oil can be removed. The filter 10 is realized as a spin-on filter. It is mounted exchangeable to a not shown filter head.

The filter 10 comprises a filter housing 12. The filter housing 12 contains a filter bowl 14 with an opening for fitting-in a filter element 16. The filter element 16 is show in detail in FIGS. 2 and 3. The opening is closed by a filter cover 18. The filter housing 12 in total is coaxial to an axis 20. In the example, the axis 20 coincides with an axis of the housing, an axis of the filter element 16 and an axis for assembling the filter 10. “Radial”, “axial”, “coaxial”, “circumferential”, “tangential” and the like refer to the axis 20 unless otherwise noted.

The filter cover 18 has a central coaxial outlet 22 for the cleaned motor oil. The outlet 22 is surrounded by an internal screw thread for connection with the filter head. Further, the filter cover 18 has multiple inlets 24 for the motor oil to be cleaned. The inlets 24 are arranged eccentrically radial outside of the outlet 22.

The filter element 16 is realized as a hollow circular filter element with a round cross-section. The filter element 16 comprises a filter medium 26. Exemplary, the filter medium 26 consists of cellulose. The filter medium 26 is folded star-shaped to a coaxial filter bellow. The filter medium 26 is surrounding an internal space 28 of the filter element 16 circumferentially. The filter medium 26 is closed in circumferential direction. The motor oil to be cleaned can flow through the filter medium 26 from radial outside to radial inside into the internal space 28.

On both axial front sides the filter medium 26 is connected to an end plate 30 and 32 each. A top end plate 30 which faces the filter cover 18 comprises a coaxial sluiceway 34. The sluiceway 34 realizes a passage through which the cleaned motor oil can leave the internal space 28 toward the outlet 22 of the filter housing 12. By the sluiceway 34 the internal space 28 is connected to the outlet 22.

A bottom end plate 32 comprises a coaxial opening 36 with a bypass valve 38. The bypass valve 38 opens a bypass to the filter medium 26 in case that a pressure difference of the motor oil on the approach side and on the outlet side exceeds a specified value.

A coaxial center tube 40 in form of a hollow cylinder is arranged in the internal space 28 of the filter element 16. The center tube 40 extends from the top end plate 30 to the bottom end plate 32. The center tube 40 is open on its both ends. The circumferential wall of the center tube 40 comprises several orifices 42 for the motor oil.

The filter element 16 is arranged in the filter housing 12 such that it separates the inlets 24 from the outlet 22. Axially between the bottom end plate 32 and a bottom 44 of the filter bowl 14 a spring 46 is arranged. By use of the spring 46 the filter element 16 is supported against the bottom 44 of the filter bowl 14.

The filter element 16 further comprises a laminar medium for acid neutralization/sequestration 48. With the medium for acid neutralization/sequestration 48 acids in the motor oil being neutralized and sequestered. The medium for acid neutralization/sequestration 48 is different from the filter medium 26.

The laminar medium for acid neutralization/sequestration 48 is realized in form of a round doughnut. It extends circumferential and radial to the axis 20 over a flat ring-shaped area. The medium for acid neutralization/sequestration 48 is arranged on the axial top front side of the filter element 16 at the outer surface of the top end plate 30 outside the internal space 28 of the filter element 16.

In the filter 10 ready for use, the medium for acid neutralization/sequestration 48 is arranged in an oil-ducting area of the filter 10 such that the motor oil can flow against its outer surface. So, the motor oil comes in contact with the medium for acid neutralization/sequestration 48. The medium for acid neutralization/sequestration 48 is arranged relating to a flow 50 of the motor oil upstream of the filter medium 26. In FIG. 1 the flow 50 of the motor oil is indicated with arrows. The acid can be neutralized/sequestered before the motor oil enters the filter medium 26.

The medium for acid neutralization/sequestration 48 comprises a supporting material. The supporting material is a matrix formed of mechanical-interlocking structural fibers and interstitial spaces. This supporting material exemplary consists of nonwoven material, in particular spunbond. On the supporting material strong base particles for acid neutralization/sequestration are immobilized to.

The medium for acid neutralization/sequestration 48 exemplary comprises strong base particles for acid neutralization/sequestration. The strong base particles exemplary being realized as strong base flocs. The strong base flocs comprise strong base particles containing magnesium oxide or zinc oxide or combination thereof. The strong base flocs exemplary can have an average particle size of about 0.1 to about 10 microns. The strong base flocs exemplary have a high molecular weight flocculating agent. The floc formed from contacting of the flocculating agent and the strong base particles exemplary have an average cross-section distance of greater than about 10 microns. The strong base particles in the floc exemplary retain at least about 40% of their intrinsic surface area as measured by a mercury intrusion porosimetry.

The particles exemplary are formed primarily from a strong base material itself. By “strong base” is meant a base that will displace the weak base from the neutral salts and return the weak base to the motor oil for recirculation for example to the piston ring zone where the weak base may be reused to neutralize additional acids. Examples of strong bases suitable for immobilization in solid base filters include, but are not limited to, barium oxide (BaO), calcium carbonate (CaCO₃), calcium oxide (CaO), calcium hydroxide (Ca(OH)₂) magnesium carbonate (MgCO₃), magnesium hydroxide (Mg(OH)₂), magnesium oxide (MgO), sodium aluminate (NaAlO₂), sodium carbonate (Na₂CO₃), sodium hydroxide (NaOH), zinc oxide (ZnO), zinc carbonate (ZnCO₃) and zinc hydroxide Zn(OH)₂ or their mixtures. Magnesium oxide and zinc oxide, or mixtures thereof, are preferred strong base materials.

The particles for neutralizing/sequestering the acids exemplary are immobilized onto a particularly thin supporting material. A layer of the medium for acid neutralization/sequestration 48 is cut from a raw material to the doughnut. The medium for acid neutralization/sequestration 48 is manufactured in combination with the filter element 16. The doughnut-formed medium for acid neutralization/sequestration 48 is placed on the top end plate 30 at the top surface of the filter element 16. Together with the filter element 16 the medium for acid neutralization/sequestration 48 is fitted into the filter housing 12.

In operation of the filter 10, the motor oil, which is contaminated with particles and acid, flows through the inlets 24 into the filter housing 12. The motor oil gets in contact with the medium for acid neutralization/sequestration. The acid being sequestered by the strong base particulates by accepting and/or retaining combustion acids or organic acids previously in the motor oil as either soluble free acids, or complexed and/or neutralized from/with detergents, dispersants, or other transfer agents.

The motor oil flows through the filter medium 26, where the particles are being filtered out. The motor oil leaves the filter 10 through the outlet 22.

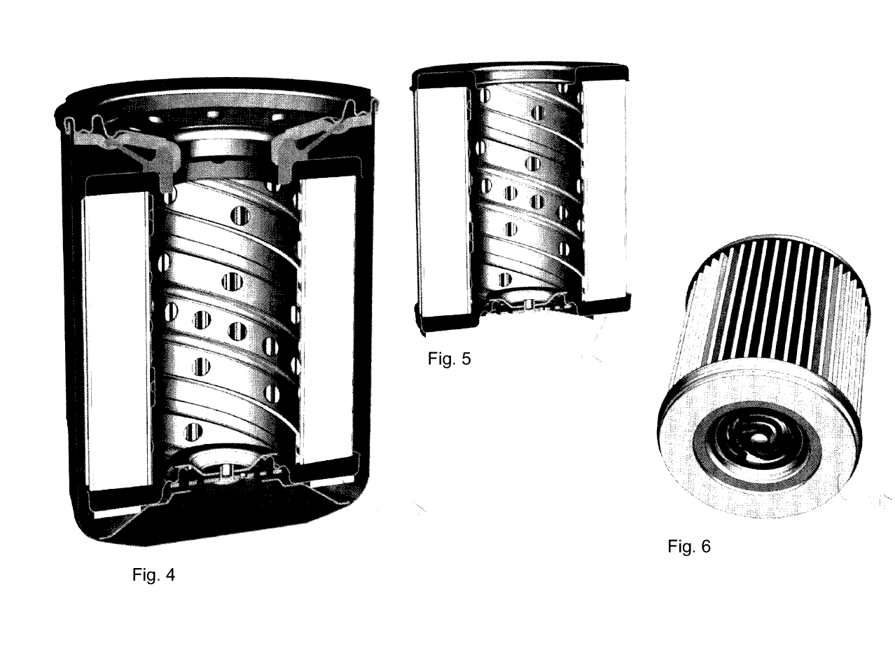

FIGS. 4 to 6 depict a second embodiment of the filter 10. Those parts which are equal to those of the first embodiment according to FIGS. 1 to 3 have the same reference numbers. Different to the first embodiment, according to the second embodiment the medium for acid neutralization/sequestration 48 is attached to the outer surface of the bottom end plate 32.

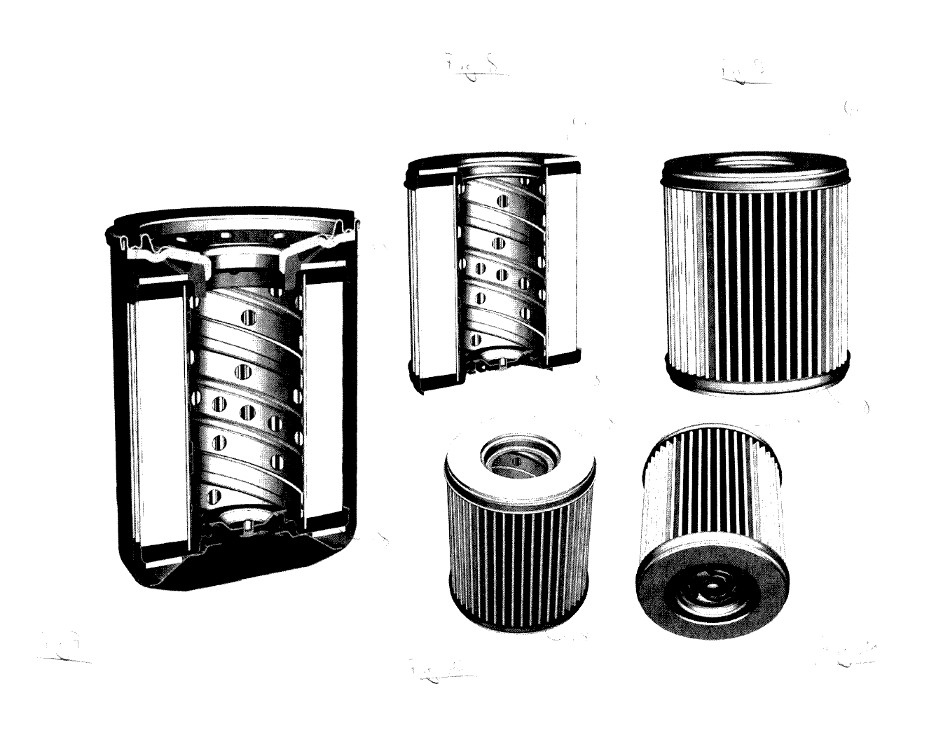

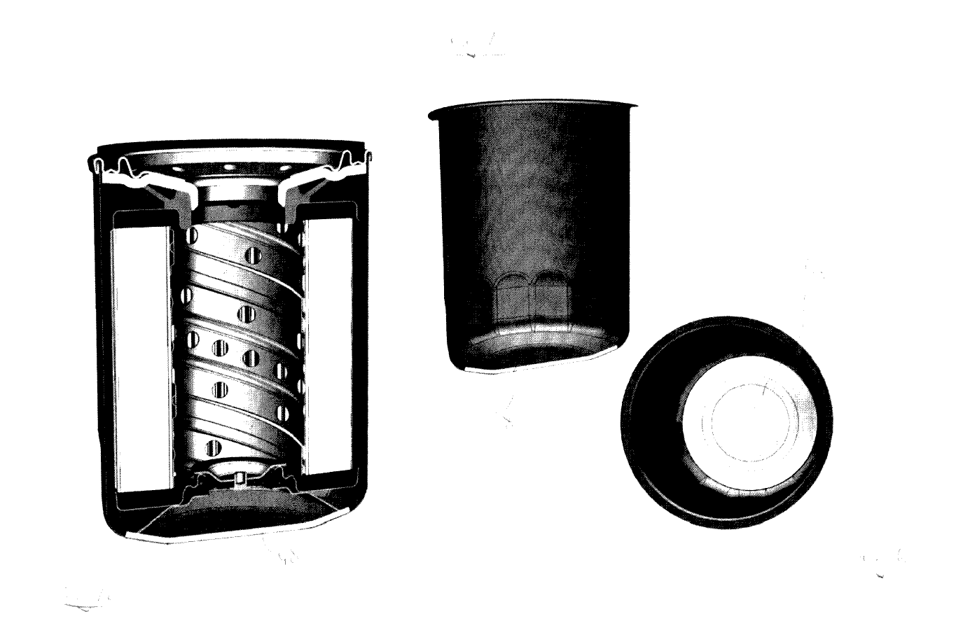

FIGS. 7 to 11 depict a third embodiment of the filter 10. Those parts which are equal to those of the first embodiment according to FIGS. 1 to 3 and the second embodiment according to FIGS. 4 to 6 have the same reference numbers. Different to the first and the second embodiment, according to the third embodiment one doughnut-formed medium for acid neutralization/sequestration 48 is attached to the topside of the top end plate 30. A second doughnut-formed medium for acid neutralization/sequestration 48, which exemplary is identical to the first medium, is attached bottom side of the bottom end plate 32.

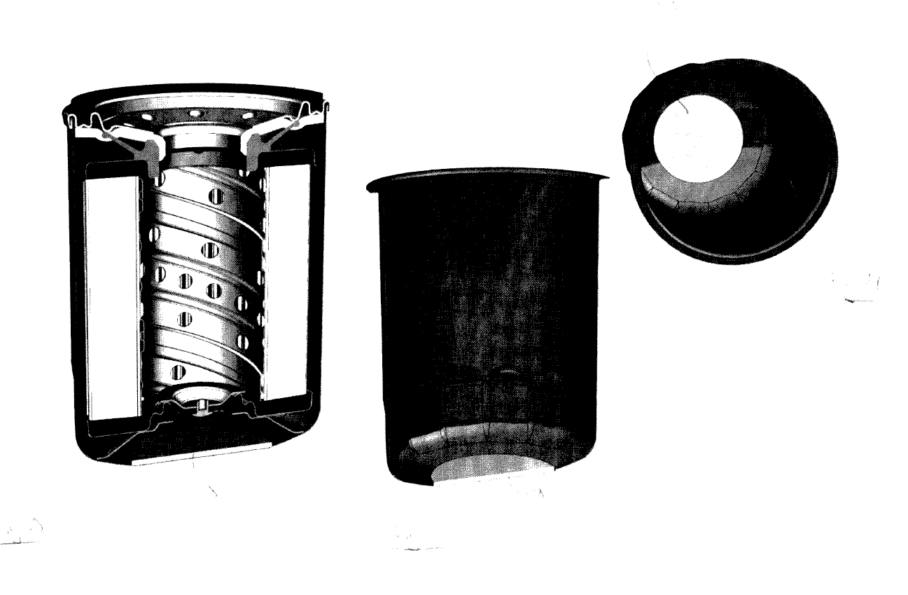

FIGS. 12 to 14 depict a fourth embodiment of the filter 10. Those parts which are equal to those of the first embodiment according to FIGS. 1 to 3 have the same reference numbers. Different to the first embodiment, according to the fourth embodiment a medium for acid neutralization/sequestration 48 is attached to the bottom 44 of the filter bowl 14. The medium for acid neutralization/sequestration 48 has the form of a round disk. One surface of the disk faces the inside of the filter bowl 14, so that the motor oil can flow against. The medium for acid neutralization/sequestration 48 is arranged between the spring 46 and the bottom 44 of the filter bowl 14 so, that the spring 46 rests on the medium for acid neutralization/sequestration 48.

FIGS. 15 to 17 depict a fifth embodiment of the filter 10. Those parts which are equal to those of the fourth embodiment according to FIGS. 12 to 14 have the same reference numbers. Different to the fourth embodiment, according to the fifth embodiment the medium for acid neutralization/sequestration 48, which is attached to the bottom 44 of the filter bowl 14, has a smaller diameter. The spring 46 rests radial outside of the medium for acid neutralization/sequestration on the bottom 44 of the filter bowl 14.

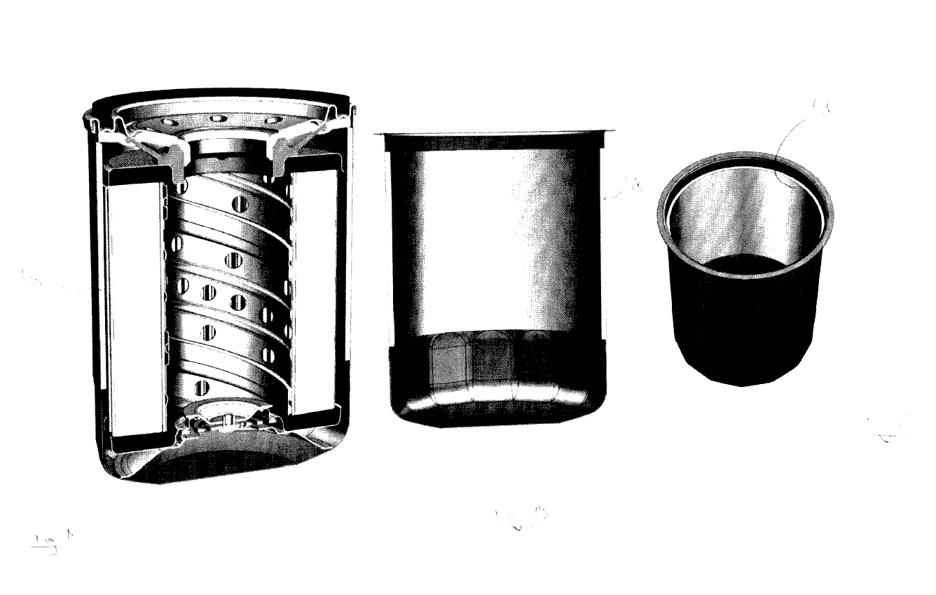

FIGS. 18 to 20 depict a sixth embodiment of the filter 10. Those parts which are equal to those of the first embodiment according to FIGS. 1 to 3 have the same reference numbers. Different to the first embodiment, according to the sixth embodiment the medium for acid neutralization/sequestration 48 has the form of a circular hollow cylinder. It is coaxial attached and stabilized to the radial inner circumferential side of the circumferential wall of the filter bowl 14. The radial inner surface of the medium for acid neutralization/sequestration 48 faces toward the inside of the filter bowl 14, so that motor oil can flow against. The medium for acid neutralization/sequestration 48 extends axially over three-quarter of the height of the filter bowl 14.

The hollow cylinder can be realized by cutting a rectangular part of medium for acid neutralization/sequestration 48 from a raw material. The rectangular part is bent or wrapped to the hollow cylinder.

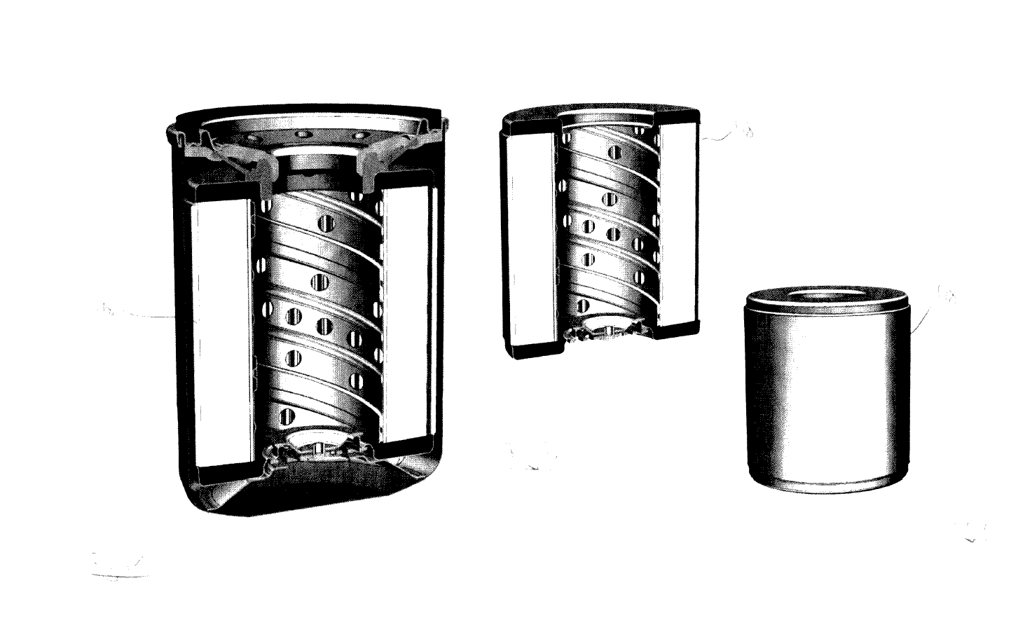

FIGS. 21 to 23 depict a seventh embodiment of the filter 10. Those parts which are equal to those of the sixth embodiment according to FIGS. 18 to 20 have the same reference numbers. Different to the sixth embodiment, according to the seventh embodiment the medium for acid neutralization/sequestration 48 in form of a circular hollow cylinder is attached to the radial outer circumferential side of the filter element 16. It is wrapped around the radial outer circumferential side of the filter medium 26 like a sleeve. The medium for acid neutralization/sequestration 48 extends axially over the full height of the filter medium 26, so that motor oil has to flow through it.

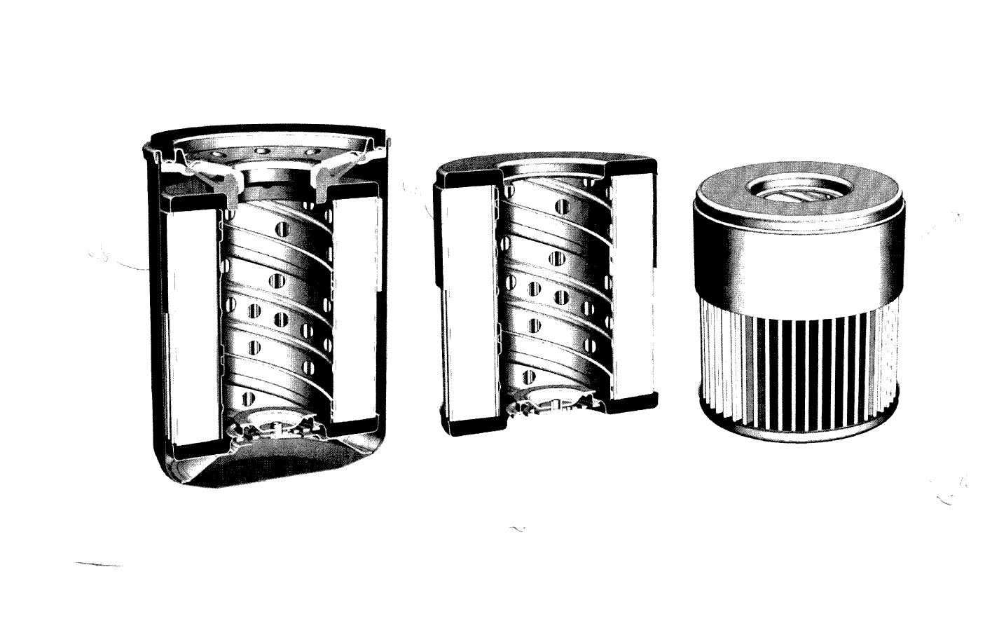

FIGS. 24 to 26 depict an eighth embodiment of the filter 10. Those parts which are equal to those of the seventh embodiment according to FIGS. 21 to 23 have the same reference numbers. Different to the seventh embodiment, according to the eighth embodiment the medium for acid neutralization/sequestration 48 in form of a coaxial circular hollow cylinder extends axially only over the upper part of the height of the filter medium 26, so that a part of the motor oil can flow through it and a part of the motor oil can circulate around it.

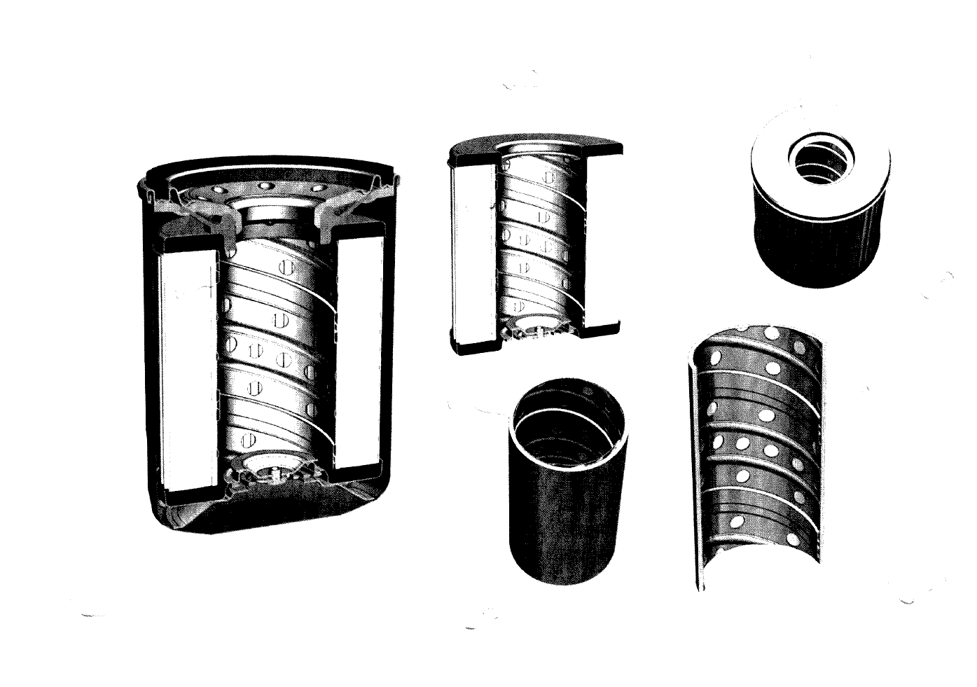

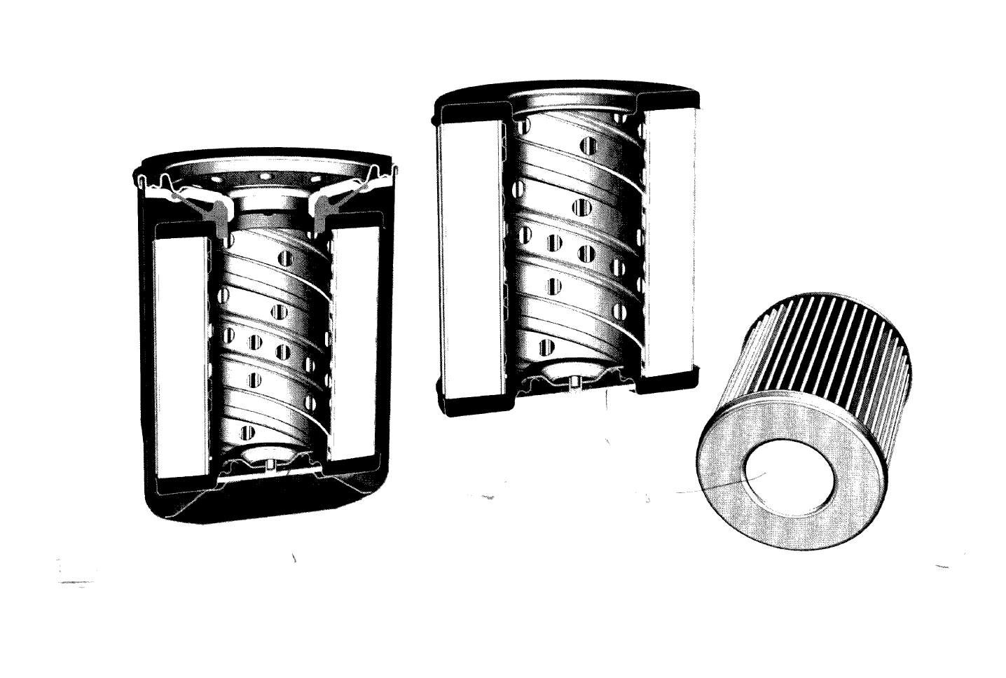

FIGS. 27 to 31 depict a ninth embodiment of the filter 10. Those parts which are equal to those of the seventh embodiment according to FIGS. 21 to 23 have the same reference numbers. Different to the seventh embodiment, according the ninth embodiment the medium for acid neutralization/sequestration 48 in form of a coaxial circular hollow cylinder is arranged in the internal space 28 of the filter element 16. It is arranged on the downstream side of the filter element 16. The medium for acid neutralization/sequestration 48 is located radial between the radial inner circumferential side of the filter medium 26 and the radial outer circumferential side of the center tube 40. The medium for acid neutralization/sequestration 48 is wrapped around the center tube 40. The medium for acid neutralization/sequestration 48 extends axially over the full height of the filter medium 26, so that the motor oil has to flow through it.

FIGS. 32 to 34 depict a tenth embodiment of the filter 10. Those parts which are equal to those of the first embodiment according to FIGS. 1 to 3 have the same reference numbers. Different to the first embodiment, according to the tenth embodiment the medium for acid neutralization/sequestration 48 has the form of a round disk. The diameter of the disk is equal to the inner diameter of the opening 36 of the bottom end plate 32 for the bypass valve 38. The medium for acid neutralization/sequestration 48 covers the bypass valve 38 on the outside facing the bottom 44 of the filter bowl 14. The medium for acid neutralization/sequestration 48 is placed between the bypass valve 38 and the spring 46. The medium for acid neutralization/sequestration 48 is on the upstream side of the filter medium 26. Under normal operating conditions, the motor oil flows from the side of the bottom 44 of the filter bowl 14 against the surface of the medium for acid neutralization/sequestration 48. In case that the bypass valve 38 opens, the lubrication oil can flow through the medium for acid neutralization/sequestration 48 and pass through the bypass valve 38.

What is claimed is:

1. A filter (10) for a liquid fluid, comprising:
a filter housing (12) including
at least one inlet (24) for fluid to be cleaned; and
at least one outlet (22) for cleaned fluid;
at least one hollow filter element (16) arranged within the filter housing (12), wherein the hollow filter element (16) separates at least one inlet (24) from at least one outlet (22);
wherein the filter element (16) includes:
at least one filter medium (26) at least partly circumferentially surrounding at least one internal space (28) in the interior of the filter element (16) about an axis (20),
at least one passage (34) connecting at least one internal space (28) conducting fluid flow to the at least one inlet (24) or the at least one outlet (22); and
at least one medium (48) operable for neutralization of acid in the fluid and/or for sequestering acid from the fluid, the at least one medium (48) arranged in a fluid-ducting area of the filter (10) such that the fluid can come in contact at least with a part of the medium for acid neutralization/sequestration (48);
wherein the at least one medium for acid neutralization/sequestration (48) is laminar and different from the at least one filter medium (26).

2. The filter according to claim 1, wherein
the at least one medium for acid neutralization/sequestration (48) is arranged such, that the fluid can flow against, pass through, circulate around, or flow along a surface of the at least one medium for acid neutralization/sequestration (48).

3. The filter according to claim 1, wherein
the at least one medium for acid neutralization/sequestration (48) is secured to or a component of the least one filter element (16).

4. The filter according claim 1, wherein
the at least one medium for acid neutralization/sequestration (48) is arranged on a circumferential side relative to the axis (20).

5. The filter according claim 1, wherein
the at least one medium for acid neutralization/sequestration (48) is arranged on at least one axial front side of at least one filter element (16) or the filter housing (12).

6. The filter according to claim 1, wherein
the at least one medium for acid neutralization/sequestration (48) is arranged inside the internal space (28) of the filter element (16).

7. The filter according to claim 1, wherein
the at least one medium for acid neutralization/sequestration (48) is arranged outside the at least one internal space (28) of the filter element (16).

8. The filter according to claim 1, wherein
the at least one medium for acid neutralization/sequestration (48) comprises at least one disk or doughnut section which extends circumferential and radial to the axis (20); and
wherein the at least one disk or doughnut section is a hollow body selected from the set: a hollow cylinder or a hollow cone.

9. The filter according to claim 1, wherein
the at least one medium for acid neutralization/sequestration (48) is arranged upstream of at least one filter medium (26) relative to the fluid flow (50).

10. The filter according to claim 1, wherein
the at least one medium for acid neutralization/sequestration (48) is arranged downstream of at least one filter medium (26).

11. The filter according to claim 1, wherein
the at least one medium for acid neutralization/sequestration (48) comprises at least one supporting material in the form of a matrix formed of mechanical-interlocking structural fibers and interstitial spaces;
wherein the at least one supporting material is at least one of a textile and a nonwoven material.

12. The filter according to claim 11, wherein
the at least one medium for acid neutralization/sequestration (48) comprises strong base particles operable for acid neutralization/sequestration.

13. The filter according to claim 12, wherein
the at least one medium for acid neutralization/sequestration (48) the strong base particles are secured to and immobilized to the supporting material.

14. A hollow filter element (16) of a filter (10) for liquid fluid configured to be arrangable within a filter housing (12) such that it separates at least one inlet (24) for fluid to be cleaned and at least one outlet (22) for cleaned fluid, the filter element comprising:
at least one filter medium (26) at least partly circumferentially surrounding at least one internal space (28) in the interior of the filter element (16) about an axis (20);
at least one passage (34) connecting at least one internal space (28) conducting fluid flow to the at least one inlet (24) or the at least one outlet (22); and
at least one acid neutralization medium (48) for neutralization of acids in the fluid and/or for sequestering acid from the fluid, the at least one acid neutralization medium arranged in a fluid-ducting area of the filter element (16) such that the fluid comes into in contact at least with a part of the at least one acid neutralization medium for acid neutralization/sequestration (48);
wherein the at least one medium for acid neutralization/sequestration (48) is secured to or a component of at the least one filter element (16);
wherein the at least one medium for acid neutralization/sequestration (48) is laminar and different from the at least one filter medium (26).

15. The hollow filter element (16) according to claim 14, wherein
the at least one acid neutralization medium (48) for neutralization of acids in the fluid and/or for sequestering acid from the fluid is arranged directly on and wrapped around a radial outer circumferential side of the filter medium.

16. A filter housing (12) of a filter (10) for filtering a liquid fluid, comprising:
an interior chamber;
at least one inlet (24) for fluid to be cleaned receiving fluid into the interior chamber;
at least one outlet (22) for cleaned fluid leaving the interior chamber;
wherein the filter housing is configured and adapted to receive a filter element according to claim 11, such that the filter element separates the at least one inlet (24) from the at least one outlet (22);
wherein the filter element (10) comprises at least one medium (48) for neutralization of acid in the fluid and/or for sequestering acid from the fluid, which can be arranged in a fluid-ducting area of the filter housing (12) such that the fluid can come in contact at least with a part of the medium for acid neutralization/sequestration (48), wherein the at least one medium for acid neutralization/sequestration (48) is combined with the filter housing (12), wherein the at least one medium for acid neutralization/sequestration (48) is laminar.
